(19) United States
(12) Patent Application Publication
(10) Pub. No.: US 2026/0285228 A1
(43) Pub. Date: Sep. 24, 2026

(54) SYSTEM AND METHOD FOR MIRROR POSITIONING

(71) Applicant: Torc Robotics, Inc., Blacksburg, VA (US)

(72) Inventors: Akshay Pai Raikar, Austin, TX (US); William Gray Davis, Austin, TX (US)

(21) Appl. No.: 19/083,805

(22) Filed: Mar. 19, 2025

(51) Int. Cl. B60R 1/06; B60R 1/07; B60R 1/08; G06T 7/73

(52) U.S. Cl. CPC B60R 1/0612; B60R 1/07; B60R 1/081; G06T 7/73; G06T 2207/30201

(57) ABSTRACT

A system for mirror positioning is provided. The system includes at least one sensor configured to be located on a vehicle and including a field-of-view within the vehicle. The vehicle includes at least one mirror configured to provide visibility of an environment external to the vehicle. The system includes a processing device configured to execute instructions stored in a memory to perform operations that include detecting with the at least one sensor a face or eyes of a driver of the vehicle, and determining a position of the face or the eyes of the driver of the vehicle. The operations include, based on the determined position of the face or the eyes of the driver of the vehicle, adjusting a position of the at least one mirror to optimize the visibility of the environment external to the vehicle in the at least one mirror for the driver.

### TECHNICAL FIELD

The field of the disclosure relates to vehicle mirror positioning and, in particular, to a system for automatically adjusting a mirror position based on a detected position of the driver's face or eyes within the vehicle for optimal visibility of the environment external to the vehicle.

### BACKGROUND

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. These actions undertaken by the vehicle include steering, braking and acceleration.

For vehicles that include a driver for at least a portion of the time of vehicle operation, mirrors of the vehicle can be used to visualize the environment external to the vehicle. Although a variety of mirrors can be used, non-limiting examples of mirrors include one or more of the following, e.g., side mirrors, fender convex mirrors, door convex mirrors, rearview mirrors, or the like. In view of the different height of each driver, before operating the vehicle, the drivers generally require specific adjustment of one or more of these mirrors to achieve their desired field-of-view. Such mirror adjustments can be time-consuming and, even after making adjustments, the mirrors may not be positioned into their optimal angle to yield the desired visualization of the environment. In addition, inadvertently forgetting to readjust the mirrors can result in unsafe operation of the vehicle.

Accordingly, there exists a need for a system and a method of mirror positioning for vehicles that yields and optimizes the visibility of the environment external to the vehicle. These and other needs are met by the exemplary system for mirror positioning discussed herein.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect, an exemplary system for mirror positioning is provided. The system includes at least one sensor configured to be located on a vehicle. The sensor includes a field-of-view within the vehicle. The vehicle includes at least one mirror configured to provide (e.g., primarily provide) visibility of an environment external to the vehicle. The system includes a processing device in communication with the at least one sensor. The processing device is configured to execute instructions stored in a memory to perform operations that include detecting with the at least one sensor a face or eyes of a driver of the vehicle. The operations include determining a position of the face or the eyes of the driver of the vehicle. The operations include based on the determined position of the face or the eyes of the driver of the vehicle, adjusting a position of the at least one mirror to optimize the visibility of the environment external to the vehicle in the at least one mirror for the driver.

The at least one sensor can be a camera and the field-of-view can be directed towards the driver of the vehicle. In some embodiments, the at least one mirror can include a right side mirror and a left side mirror. In some embodiments, the at least one mirror can include a fender convex mirror, a door convex mirror, or both. In some embodiments, the at least one mirror includes a rearview mirror.

The operations can include monitoring the position of the face or the eyes of the driver of the vehicle over time. The operations can include readjusting the position of the at least one mirror based on a change in the position of the face or the eyes of the driver of the vehicle over time relative to an initial position of the face or the eyes of the driver of the vehicle. In some embodiments, the operations can include readjusting the position of the at least one mirror based on the change in the position of the face or the eyes of the driver of the vehicle in real-time. In some embodiments, the operations can include readjusting the position of the at least one mirror based on the change in the position of the face or the eyes of the driver of the vehicle after a predetermined period of time.

The system can include a database with correlation data between the position of the face or the eyes of the driver and a target position of the least one mirror for optimized visibility of the environment eternal to the vehicle in the at least one mirror. In some embodiments, detecting the face or the eyes of the driver and determining the position of the face or the eyes of the driver can be performed before initial driving of the vehicle upon entry of the driver into the vehicle. In some embodiments, detecting the face or the eyes of the driver and determining the position of the face or the eyes of the driver can be performed upon a change in the driver of the vehicle.

In some embodiments, adjusting the position of the at least one mirror can include aligning the position of the at least one mirror with a line-of-sight of the eyes of the driver. In some embodiments, adjusting the position of the at least one mirror can include actuating a rotary unit associated with the at least one mirror to reposition the at least one mirror. In some embodiments, the vehicle can be an autonomous vehicle, a semi-autonomous vehicle, and/or a non-autonomous vehicle.

In another aspect, an exemplary computer-implemented method for mirror positioning is provided. The method includes detecting with at least one sensor configured to be located on a vehicle and including a field-of-view within the vehicle a face or eyes of a driver of the vehicle. The vehicle includes at least one mirror configured to provide visibility of an environment external to the vehicle. The method includes executing instructions stored in a memory with a processing device in communication with the at least one sensor to perform operations that include determining a position of the face or the eyes of the driver of the vehicle. The operations include based on the determined position of the face or the eyes of the driver of the vehicle, adjusting a position of the at least one mirror to optimize the visibility of the environment external to the vehicle in the at least one mirror for the driver.

In some embodiments, the operations can include monitoring the position of the face or the eyes of the driver of the vehicle over time. In some embodiments, the operations can include readjusting the position of the at least one mirror based on a change in the position of the face or the eyes of the driver of the vehicle over time relative to an initial position of the face or the eyes of the driver of the vehicle. In some embodiments, the operations can include readjusting the position of the at least one mirror based on the change in the position of the face or the eyes of the driver of the vehicle in real-time. Adjusting the position of the at least one mirror can include aligning the position of the at least one mirror with a line-of-sight of the eyes of the driver.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic perspective view of an autonomous truck.

FIG. 2 is a schematic perspective view of an autonomous truck and trailer.

FIG. 3 is a schematic side view of an autonomous truck and trailer.

FIG. 4 is a block diagram of the autonomous truck shown in FIGS. 1-3.

FIG. 5 is a block diagram of an example computing system.

FIG. 6 is a block diagram of an exemplary system for mirror positioning.

FIG. 7 is a flowchart of a method for mirror positioning.

FIG. 8 is a top view of a vehicle including multiple mirrors and their respective field-of-view at ground level and approximately 1.2 m above ground level, including planar mirrors, A-pillar mirrors, fender convex mirrors, window openings, and door convex mirrors.

FIG. 9 is a top down view of a vehicle including mirror locations and their respective field-of-view.

FIG. 10 is a view of an interior of a vehicle including side door mirrors and an interior sensor.

FIG. 11 is a top down view of an interior of a vehicle including an interior sensor with a field-of-view for detecting a driver position.

FIG. 12 is an image captured by an interior sensor of an exemplary system for mirror positioning to detect a driver position.

FIG. 13 is a block diagram of frames of reference used by an exemplary system for mirror positioning to optimize a field-of-view of a mirror.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

The exemplary system for mirror positioning provides a means for automatically calibrating the position of mirrors for a vehicle based on a driver's position to maximize the field-of-view for the driver. In particular, the system includes at least one sensor within the vehicle capable of detecting the face and/or eyes of the driver, and automatically adjusts the position of the mirrors to optimize the visibility of the environment external to the vehicle in the mirrors. The system allows for a customized positioning of the mirrors based on the driver's characteristics. Therefore, when a new driver sits in the vehicle and/or if the position or orientation of the driver changes over time during operation of the vehicle (e.g., sitting lower or higher than an initial position), the system adjusts in real-time (or substantially real-time) the position of the mirrors to ensure optimal visibility for the driver. The system reduces the time required by the driver to operate the mirrors and ensures safe operation of the vehicle based on improved visibility of the environment. By positioning the mirrors in an optimal orientation based on the driver's position, the driver is able to operate the vehicle and/or monitor the dynamic driving tasks performed by an autonomous or semi-autonomous vehicle.

The sensor of the system can include, e.g., a camera, or the like, within the vehicle with a field-of-view facing the driver of the vehicle. The sensor can capture characteristics associated with the driver and representative of the position and/or orientation of the driver, e.g., the relative and absolute position and orientation of the driver's head, face and/or eyes. In some embodiments, the sensor data can be used in a three-dimensional geometric algorithm to determine the driver characteristics. In some embodiments, correlation data can be used to detect and determine the driver characteristics relative to the mirror positions. In particular, the sensor location in the vehicle and the location of the mirrors is known. The data captured by the sensor can be correlated to determine the optimal position of the mirrors relative to the detected features of the driver and the known position of the sensor and mirrors. The system can communicate with an adjustment mechanism associated with the mirrors, e.g., a motor, or the like, to selectively adjust the position of the mirrors.

The system can determine the optimal position of the mirrors based on industry standards or local vehicle operation laws. In some embodiments, the optimal position of the mirrors can be based on specifications mandated by, e.g., Federal Motor Vehicle Safety Standards (FMVSS), or the like. In some embodiments, the optimal position of the mirrors can be based on 49 CFR § 571.111 for rear visibility standards. For example, under S 5.1.1 regarding the field-of-view, the mirror shall provide a field-of-view with an included horizontal angle measured from the projected eye point of at least 20 degrees, and a sufficient vertical angle to provide a view of a level road surface extending to the horizon beginning at a point not greater than 61 m to the rear of the vehicle when the vehicle is occupied by the driver and four passengers or the designated occupant capacity, if less, based on an average occupant weight of 68 kg. (See 49 CFR § 571.111). The line of sight may be partially obscured by seated occupants or by head restraints. See id. The location of the driver's eye reference points shall be those established in Motor Vehicle Safety Standard No. 104 (§ 571.104) or a nominal location appropriate for any 95th percentile male driver. See id.

The system can therefore use three-dimensional geometry to automatically align the mirrors based on the pose of the driver's head (e.g., face and/or eyes) to maximize the field-of-view available to the driver. In some embodiments, the adjustment mechanism for the mirrors can include a motor. In some embodiments, the adjustment mechanism for the mirrors can include a servomotor to provide precise control of the mirror position. The adjustment mechanism therefore provides a precise measurement and corresponding field-of-view alignment error reduction in operation. As discussed herein, the field-of-view alignment error refers to the difference between the area of the ellipse formed at the mandated distance of, e.g., 61 m, by the current orientation of the mirror relative to the driver, versus the desired elliptical field-of-view.

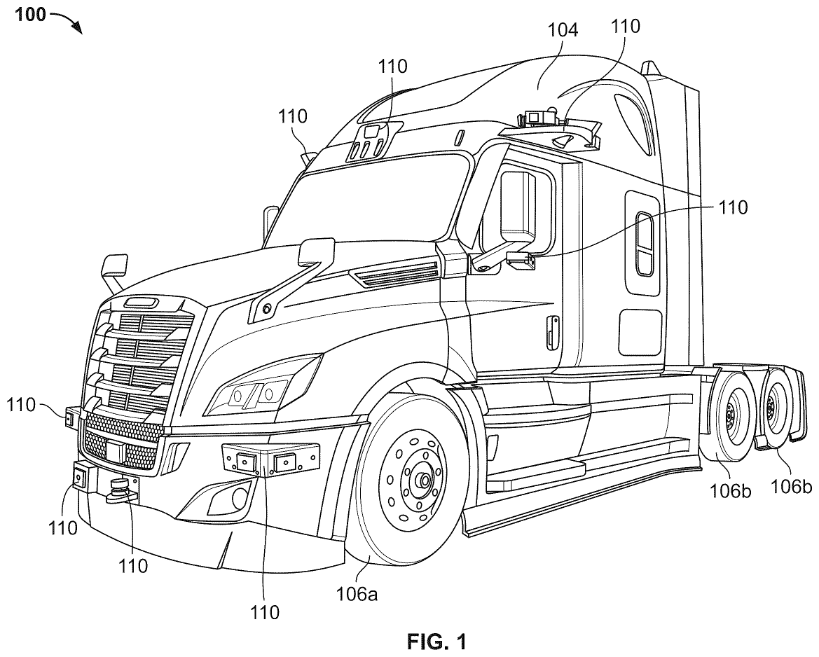

Various embodiments in the present disclosure are described with reference to FIGS. 1-13 below.

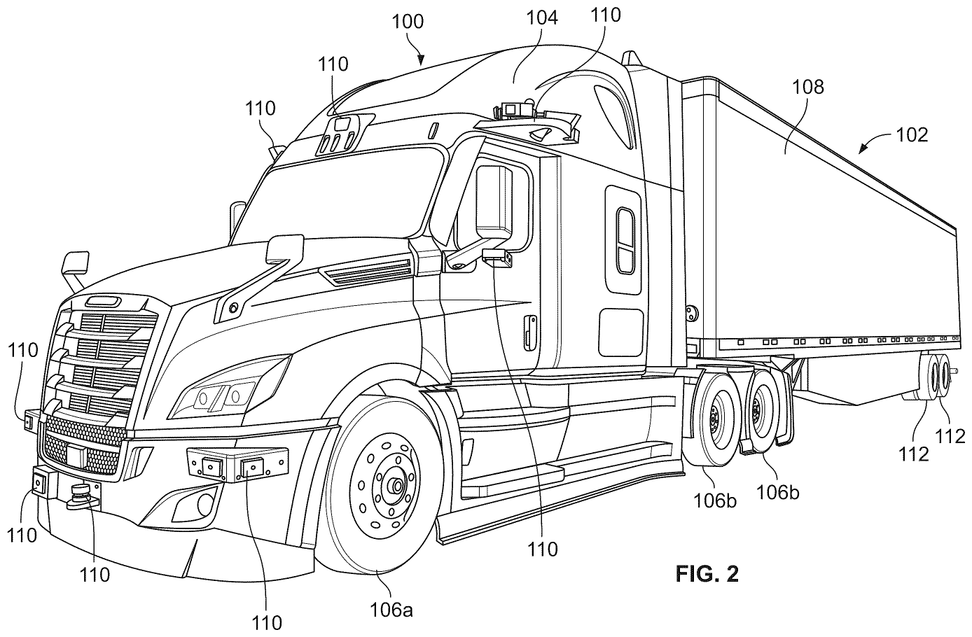

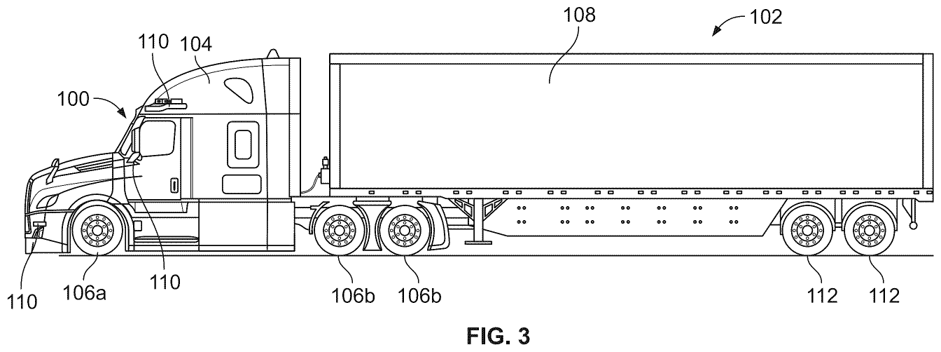

FIG. 1 is a perspective view of a vehicle 100, such as a truck that may be conventionally connected to a single or tandem trailer 102 to transport the trailer 102 to a desired location, as shown in FIGS. 2 and 3, which are, respectively, perspective and side views of the vehicle 100 of FIG. 1 with the trailer 102 attached thereto. The vehicle 100 includes a cabin 104 that can be supported, and steered in the required direction, by front wheels 106a and rear wheels 106b that are partially shown in FIG. 1. The front wheels 106a are positioned by a steering system that includes a steering wheel and a steering column (not shown). The steering wheel and the steering column may be located in the interior of cabin 104.

The vehicle 100 may be an autonomous vehicle, in which case the vehicle 100 may omit the steering wheel and the steering column to steer the vehicle 100. Rather, the vehicle 100 may be operated by an autonomy computing system of the vehicle 100 based on data collected by a sensor network including one or more sensors, e.g., sensors 110 shown in FIGS. 1-3. The vehicle 100 may additionally include a fifth-wheel coupling (not shown) to which the trailer 102 can be releasably attached. The trailer 102 can include a storage container 108 and a plurality of rear wheels 112 that support the storage container 108. It should be understood that in some embodiments the vehicle 100 and the trailer 102 can be a permanently attached as a single unit.

The sensors 110 have a field-of-view at the front, sides and/or rear of the vehicle 100. Similar sensors 110 can be used around the perimeter of the vehicle 100 to ensure full environmental coverage around the vehicle 100 is provided by the sensors 110. In some embodiments, the vehicle 100 can include, e.g., 5-6 LIDAR sensors, 8-10 cameras, combinations thereof, or the like. In some embodiments, the vehicle 100 can tow a trailer 102 and the trailer 102 can similarly include LIDAR sensors and/or cameras to provide field-of-view coverage around the perimeter of the vehicle 100 and the trailer 102. The environmental coverage by the sensors and/or cameras therefore provides data corresponding with the front, rear, sides and corners of the vehicle 100 and the trailer 102 hauled by the vehicle 100.

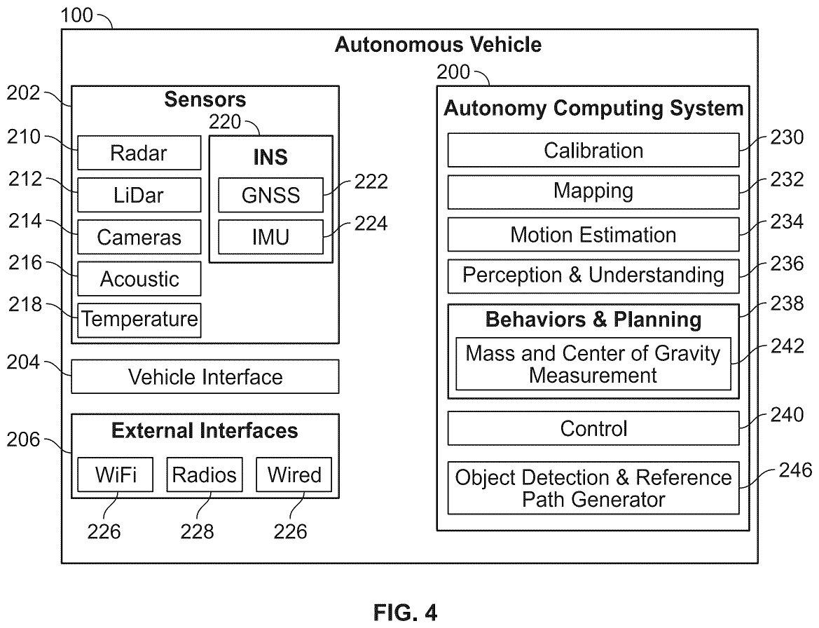

FIG. 4 is a block diagram representing autonomous vehicle 100 shown in FIGS. 1-3. In the example embodiment, autonomous vehicle 100 generally includes autonomy computing system 200, sensors 202, a vehicle interface 204, and external interfaces 206. It should be understood that the sensors 110 on the vehicle 100 in FIGS. 1-3 and described herein correspond to the sensors identified as 202 in FIG. 4. The sensors 110 may specifically comprise any of the sensors 210-220 shown in FIG. 4 and described herein.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers in the environment surrounding autonomous vehicle 100. In some embodiments, the image data generated by cameras 214 may be sent to autonomy computing system 200 or other aspects of autonomous vehicle 100 for one or more of identifying objects around the vehicle 100, updating a reference path based on the detected objects, and controlling operation of the vehicle 100 to guide the vehicle 100 along its route.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100. In some embodiments, the trailer associated with the vehicle 100 can include similar sensors 202 for gathering similar data associated with the trailer, thereby further assisting with control operations of the autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 226, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a mass and center of gravity measurement module 242, a control module or controller 240, and an object detection and reference path generator module 246. The object detection and reference path generator module 246, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

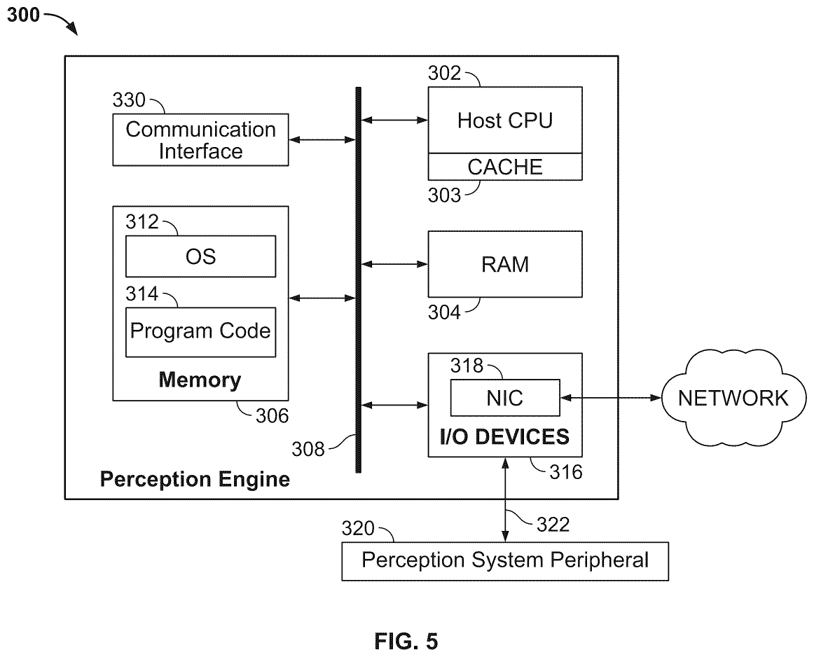

FIG. 5 is a block diagram of an example computing system 300, such as the autonomy computing system 200 shown in FIG. 4, configured for sensing an environment in which an autonomous vehicle is positioned. Computing system 300 includes a CPU 302 coupled to a cache memory 303, and further coupled to RAM 304 and memory 306 via a memory bus 308. Cache memory 303 and RAM 304 are configured to operate in combination with CPU 302. Memory 306 is a computer-readable memory (e.g., volatile, or non-volatile) that includes at least a memory section storing an OS 312 and a section storing program code 314. Program code 314 may be one of the modules in the autonomy computing system 200 shown in FIG. 4. In alternative embodiments, one or more sections of memory 306 may be omitted and the data stored remotely. For example, in certain embodiments, program code 314 may be stored remotely on a server or mass-storage device and made available over a network 332 to CPU 302.

Computing system 300 also includes I/O devices 316, which may include, for example, a communication interface such as a network interface controller (NIC) 318, or a peripheral interface for communicating with a perception system peripheral device 320 over a peripheral link 322. I/O devices 316 may include, for example, a GPU for image signal processing, a serial channel controller or other suitable interface for controlling a sensor peripheral such as one or more acoustic sensors, one or more LiDAR sensors, one or more cameras, or a CAN bus controller for communicating over a CAN bus.

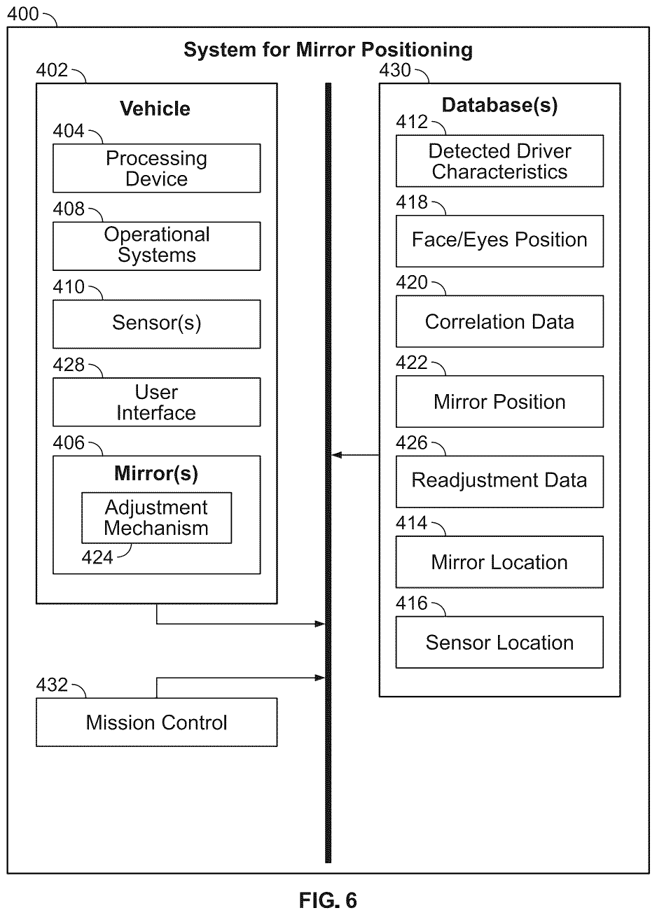

FIG. 6 is a block diagram of an exemplary system 400 for mirror positioning of a vehicle. The system 400 generally includes one or more vehicles 402 (e.g., autonomous vehicle 100, semi-autonomous vehicle, and/or non-autonomous vehicle). The vehicle 402 includes a processing device 404 (e.g., computing system 200, computing system 300, or the like) configured to receive and process data for positioning and adjusting the position of mirrors 406 of the vehicle 402. The vehicle 402 can include one or more operational systems 408 (e.g., mapping 232, motion estimation 234, perception and understanding 236, behaviors and planning 242, control 240, object detection and reference path generator 246, combinations thereof, or the like) for operating the vehicle 402 within an environment.

The vehicle 402 can include one or more sensors 410 (e.g., sensors 202) for detecting the environment and objects within the environment around the vehicle 402. At least one of the sensors 410 (e.g., a camera, infrared sensor, combinations thereof, or the like) can include a field-of-view directed into the vehicle 402 to capture characteristics 412 associated with the driver of the vehicle 402. In particular, the location 414 of each of the mirrors 406 of the vehicle 402 can be known and programmed into the system 400. The location 416 of the sensor 410 is also known and programmed into the system 400. In some embodiments, the location 416 of the sensor 410 can be at or near a rearview mirror 406 of the vehicle 402.

The sensor 410 captures data regarding the driver when the driver is sitting in the appropriate driver's seat of the vehicle 402, and object/feature detection algorithms can be executed by the processing device 404 to detect certain characteristics 412 of the driver, e.g., face position, eye position, or the like. The face and/or eye position 418 obtained from the characteristics 412 can be stored in the system 400. Based on the input of known mirror location 414, sensor location 416 and face/eye position 418 of the driver into the processing device 404, correlation data 420 can be generated by the processing device 404 to determine the optimal mirror position 422 for maximizing the visibility and/or field-of-view for the driver through the mirrors 406.

After the optimal mirror position 422 is determined (e.g., the target position), the processing device 404 can communicate with an adjustment mechanism 424 (e.g., DC motor, servomotor, or the like) of the respective mirror 406 to adjust the position of the mirror 406 and achieve the optimal mirror position 422 for the specific driver of the vehicle 402. The adjustment mechanism 424 can be operated to align the position of the mirror 406 with a line-of-sight of the eyes of the driver to ensure maximum visibility by the driver.

In some embodiments, the mirror 406 positioning operation can be performed each time the driver first sits within the vehicle 402, e.g., before or immediately after start-up of the vehicle 402. In some embodiments, the mirror 406 positioning operation can be performed in real-time during operation of the vehicle 402, e.g., continuously monitoring the position 418 of the face and/or eyes of the driver and independently readjusting the position of the mirrors 406 to achieve the optimal mirror 406 position, e.g., readjustment data 426. In some embodiments, the mirror 406 positioning operation can be performed at a predetermined frequency, e.g., every hour, every few hours, or the like. Thus, if the position of the driver changes over time, e.g., if the driver sits lower in the driver's seat after a long period of operation of the vehicle 402, the system 400 automatically adjusts the mirror 406 position to accommodate the driver's repositioning, thereby ensuring continued optimal visibility of the environment external to the vehicle 402.

The vehicle 402 includes a user interface 428 (e.g., vehicle interface 204) configured to receive/transmit and display data for operation of the system 400, as well as the vehicle 402 itself. In some embodiments, the user interface 428 can display confirmation that the mirror 406 adjustment operation has been performed by the vehicle 402. In some embodiments, the user interface 428 can request confirmation from the driver that a mirror 406 adjustment operation should be performed by the vehicle 402. A single action can therefore be taken by the user via the user interface 428 to confirm that the vehicle 402 should automatically adjust the position of all mirrors 406. In some embodiments, the user interface 428 can display an alert to the driver, e.g., a countdown, or the like, indicating that the sensor(s) 410 will initiate capture of data for the mirror 406 repositioning in order to ensure that accurate driver characteristics 412 are obtained by the sensors 410.

The vehicle 402 can include one or more databases 430 (e.g., memory 306) configured to receive and electronically store data. In some embodiments, the database 430 can be stored externally from the vehicle 402 and the vehicle 402 can be in communication with the external database 430 for receiving and/or transmitting data associated with the system 400. In some embodiments, the database 430 can be located at mission control 432 (or at any other external location proximate a control unit) external to the vehicle 402 and in communication with the vehicle 402. In some embodiments, the database 430 can be located on the vehicle 402 itself. In some embodiments, one or more portions of the database 430 can be distributed across components of the system 400. The database 430 can store information relating to data captured by the sensors 410, sensor 410 characteristics, mirror 406 characteristics, and driver characteristics 412.

The system 400 therefore automatically adjust the position of the mirrors 406 based on characteristics 412 specific to the driver operating the vehicle 402 (or sitting in the driver's seat). The system 400 accommodates drivers of different sizes/heights, and can adjust in real-time (or substantially real-time) for repositioning of the driver within the vehicle 402. The system 400 therefore ensures that maximum visibility is maintained for the driver through the mirrors 406 at all times, resulting in safe operation of the vehicle 402 without the hassle of manually adjusting the mirror 406 position.

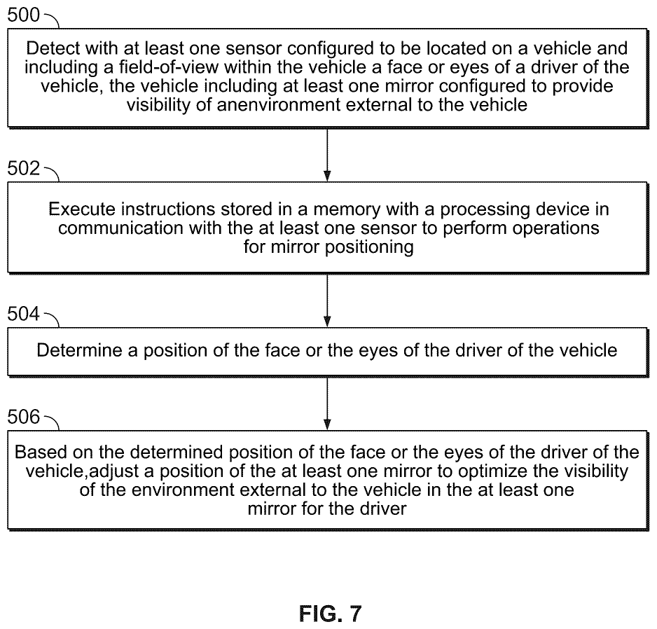

FIG. 7 is a flowchart of a method of mirror positioning by the exemplary system 400 discussed herein. At 500, a face and/or eyes of the driver of the vehicle are detected by at least one sensor configured to be located on a vehicle and including a field-of-view within the vehicle. The vehicle includes at least one mirror configured to provide visibility of an environment external to the vehicle. At 502, instructions stored in a memory are executed with a processing device in communication with the at least one sensor to perform operations for mirror positioning.

At 504, a position of the face or eyes of the driver of the vehicle is determined based on the data captured by the at least one sensor. At 506, based on the determined position of the face or eyes of the driver of the vehicle, a position of the least one mirror is adjusted to optimize the visibility of the environment external to the vehicle in the at least one mirror for the driver.

In some embodiments, the chassis frame of reference can be programmed into the database of the vehicle, thereby providing relative relationships between the sensor, mirror and driver (or driver's seat) locations. The sensor and mirrors of the vehicle can be fixed to the chassis with a known location. The driver frame can be calculated based on the relative pose of the driver with respect to the sensor or camera within the vehicle capturing data associated with the driver. The sensor and mirror positions are therefore known and non-variable components of the determination, while the driver position is a variable determination based on characteristics associated with the driver.

Pillar mirrors can be modified to include configurable pan and tilt angles. Based on the data of the sensor, mirrors and driver, the processing device can determine the three-dimensional points in the two-dimensional frame of the driver using a series of back transforms. Calibrations for the sensors and the mirrors are known beforehand at the time of calibration (e.g., performed during a pre-check departure). An iterative perspective and point method can be used to optimize the field-of-view of the mirrors for the driver based on the input information.

In some embodiments, the method of optimizing the field-of-view of the mirrors can be performed as follows. The system determines the head-pose or location of the driver, which is provided to the system with angles and a coordinate position in three-dimensional space. The system applies back transforms to evaluate the field-of-view of the driver at the current head position. The system evaluates the difference between the desired field-of-view and the current field-of-view. The system solves the optimization problem in variables (e.g., four to six variables, or the like) to determine the correct pan and tilt angle changes for the mirrors in order to match the desired field-of-view. These optimal pan and tilt angle changes are communicated by the system to the pan-tilt controller for the respective mirrors via a communication system, e.g., a controller area network (CAN) protocol, a local interconnect network (LIN) protocol, or the like. The controller actuates the motors associated with the mirrors to change the pan and tilt angles according to the instructions from the controller.

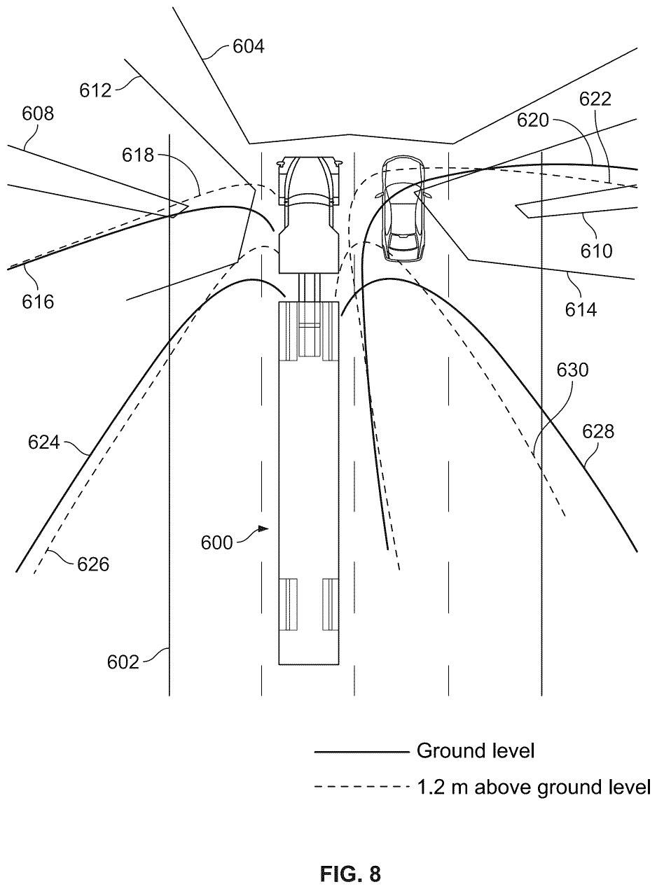

FIG. 8 is a top view of a vehicle 600 traveling on a roadway 602 and including multiple mirrors and their respective fields-of-view. The solid lines represent the field-of-view at ground level and the dashed lines represent the field-of-view above ground level, e.g., at about 1.2 m above ground level. In some embodiments, the vehicle 600 can include, e.g., a right planar mirror, a left planar mirror, A-pillar mirrors, fender convex mirrors, door convex mirrors, a rearview mirror, combinations thereof, or the like. FIG. 8 therefore provides a non-limiting example of different mirrors and their respective fields-of-view, although the exemplary system can be operated in combination with any mirror types and any vehicle configurations.

The A-pillar mirror can provide a fields-of-view 604. The left planar mirror and the right planar mirror can provide respective fields-of-view 608, 610. The driver can have the fields-of-view 612, 614 on opposing sides of the vehicle 600 through window openings. The left fender convex mirror can provide a field-of-view 616 at ground level and a field-of-view 618 above ground level. Similarly, the right fender convex mirror can provide a field-of-view 620 at ground level and a field-of-view 622 above ground level. The left door convex mirror can provide a field-of-view 624 at ground level and a field-of-view 626 above ground level. Similarly, the right door convex mirror can provide a field-of-view 628 at ground level and a field-of-view 630 above ground level.

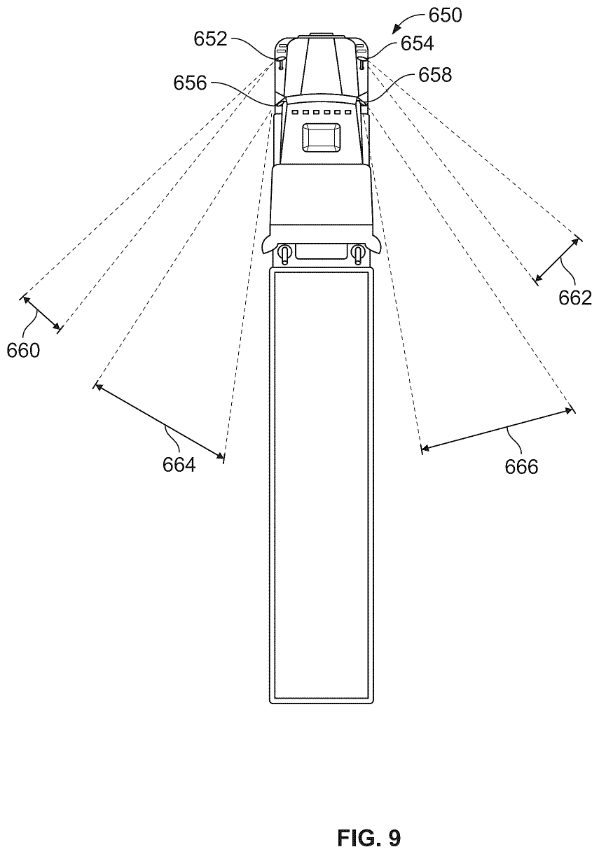

FIG. 9 is a top down view of a vehicle 650 including various mirror positions and fields-of-view from the driver's seat. While FIG. 8 illustrates the parabolic nature of at least some of the mirrors, including fields-of-view and potential blind spots, FIG. 9 illustrates the fields-of-view in a more linear manner. The vehicle 650 can include left and right fender convex mirrors 652, 654, and left and right door convex mirrors 656, 658. The fender convex mirrors 652, 654 have respective fields-of-view 660, 662, and the door convex mirrors 656, 658 have respective fields-of-view 664, 666.

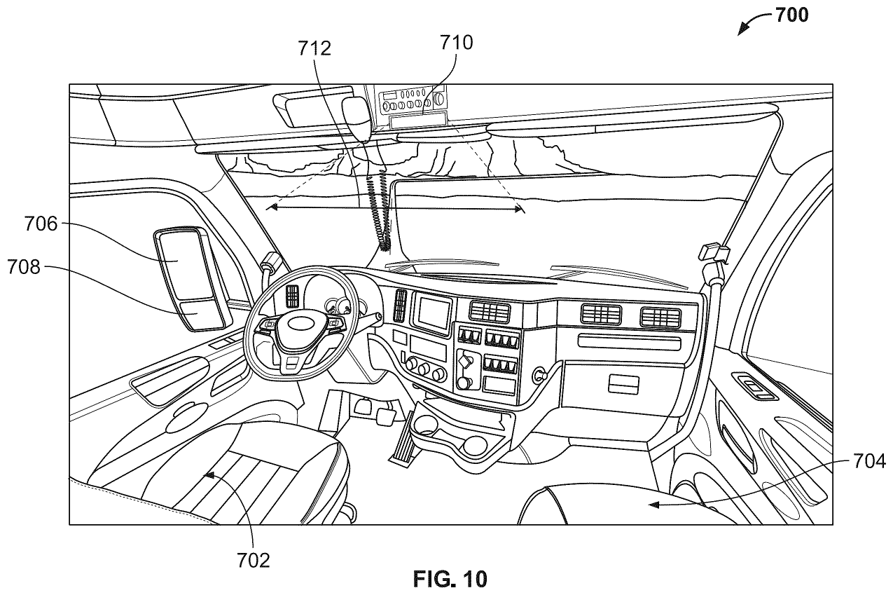

FIG. 10 is a view of an interior of a vehicle 700. The interior can include a driver's seat 702 and a passenger seat 704. The vehicle 700 includes at least one side door mirror 706, and can include additional mirrors, such as the convex mirror 708. The vehicle 700 includes at least one sensor 710 disposed within the interior of the vehicle 700 and configured to detect characteristics associated with the driver when the driver is in the seat 702. In some embodiments, the sensor 710 can be disposed at or near a rearview mirror position within the vehicle 700. The sensor 710 includes a field-of-view 712 directed towards the seat 702, thereby capturing data relating to the driver. The data can be processed by the system to identify the spatial position of the face and/or eyes of the driver, and this information is used to identify the optimal position of the mirrors 706, 708 to maximize visibility of the environment exterior to the vehicle 700.

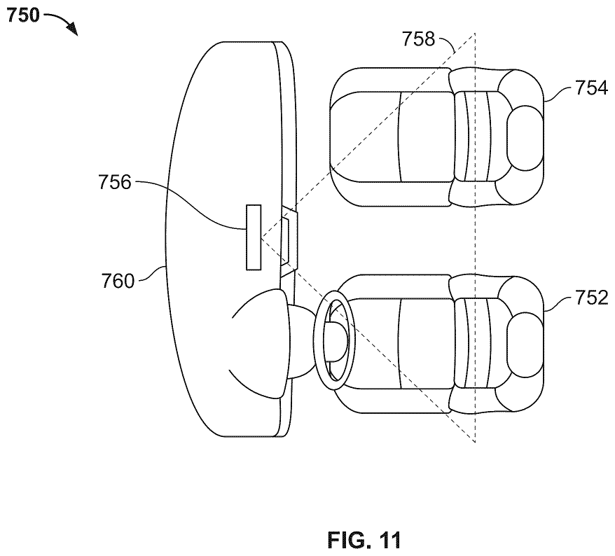

FIG. 11 is a diagrammatic top down view of an interior of a vehicle 750 including a driver's seat 752 and a passenger seat 754. The vehicle 750 includes at least one sensor 756 including a field-of-view 758 for capturing details regarding the driver in the seat 752. In some embodiments, the sensor 756 can be a camera with a wide angle lens. In some embodiments, the sensor 756 can be disposed substantially centrally within the interior of the vehicle 750. For example, the sensor 756 can be disposed substantially centrally relative to a windshield 760, e.g., at or near a position of a rearview mirror, to sufficiently capture details associated with the driver in the field-of-view 758.

FIG. 12 is an image 800 captured by a sensor disposed within a vehicle. The captured image 800 includes at least a partial view of the driver 802. Image or object recognition algorithms can be used by the system to identify certain features within the image 800. In particular, the algorithms can be used to identify the face of the driver 802 and a bounding box 804 can be generated around the driver's face. A similar bounding box 806 is shown generated around the face of the passenger. The generated driver's bounding box 804 can be maintained and updated in substantially real-time by the system as the driver 802 moves or repositions himself within the vehicle.

In some embodiments, the identification of the bounding box 804 for the face of the driver 802 can be sufficiently used by the exemplary system to adjust the position of the mirrors of the vehicle to optimize visibility for the driver 802. In some embodiments, the data from the image 800 can further be used to identify the eyes 808, 810 of the driver 802, thereby ensuring a more accurate adjustment of the mirrors of the vehicle. After the eyes of the driver 802 have been identified using object or image recognition algorithms, based on the known location of the sensor capturing the image 800 and the known position of the mirror(s), the system can correlate and determine the optimal mirror position for maximum visibility for the eyes 808, 810 of the driver 802. In some embodiments, the operation can be performed in substantially real-time to continuously adjust the position of the mirrors based on the position of the driver 802. In some embodiments, identified object data 812 can be provided in the captured image 800, e.g., the identified spatial position of the face, the angle (pitch and yaw) of the face), the eye openness, the mouth openness, or the like. The exemplary system can incorporate pose estimation algorithms which receive as input the six degrees of freedom data of the center of the eye line (e.g., line joining eye centers of driver), and use this data to align the mirrors.

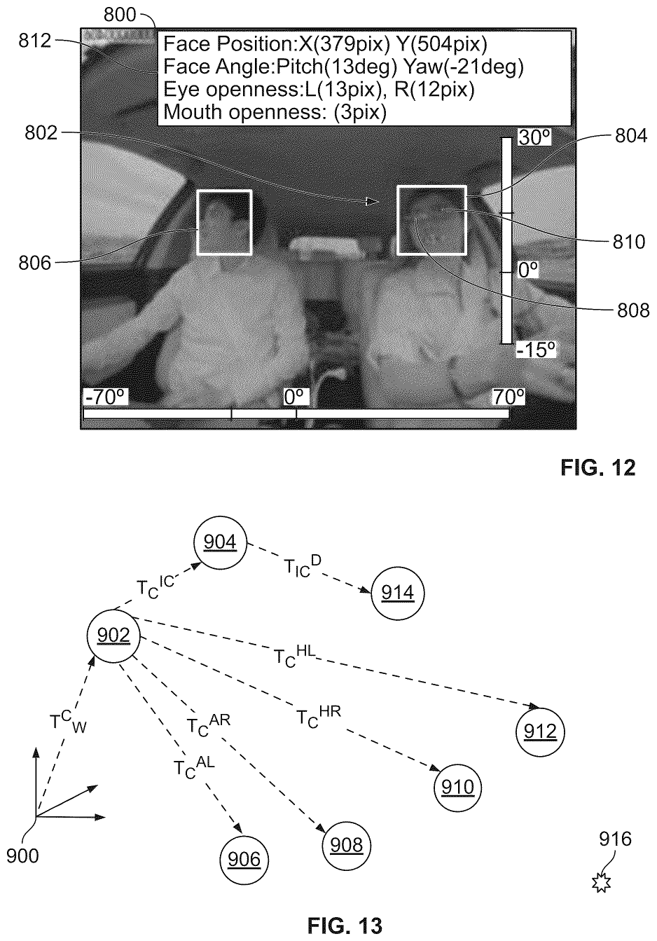

FIG. 13 is a block diagram of frames of reference used by the exemplary system to identify the optimal position of the mirrors. A global coordinate system 900 (e.g., x-axis, y-axis, z-axis) is used to spatially identify components of the system. The system 900 can be used to program the processing device of the vehicle to perform operations associated with the exemplary system for identification of the driver relative to spatially fixed components of the vehicle. The position of the vehicle chassis 902 is identified in space by known coordinates T^{C}_{W}. The sensor 904 position relative to the vehicle chassis 902 is identified by known coordinates T_{C}^{IC}.

Various mirror 906, 908, 910, 912 positions relative to the vehicle chassis 902 are identified by respective coordinates T_{C}^{AL}, T_{C}^{AR}, T_{C}^{HR}, and T_{C}^{HL}. In some embodiments, the mirrors 906, 908, 910, 912 can include, e.g., an A-pillar mirror left, an A-pillar mirror right, a hood mirror right, a hood mirror left, or the like. The locations of the vehicle chassis 902, the sensor 904, and the mirrors 906, 908, 910, 912 are therefore known and not variable for the system calculations. When a driver 914 sits within the vehicle, the sensor 904 captures data which is processed to determine the spatial location/position, i.e., coordinates T_{C}^{D}, of the driver 914 relative to the sensor 904. The system processes each of the coordinates based on the driver 914 information to determine the optimal position of the respective mirrors 906, 908, 910, 914 to maximize visibility of the exterior environment, e.g., a three-dimensional point 916 in the environment. By using the frames of reference illustrated in FIG. 13, the exemplary system is able to accurately identify the optimal line-of-sight for the driver 914 and automatically adjusts the mirrors to achieve the optimal positioning. Based on the frames of reference, the system transmits signals to an adjustment mechanism (e.g., a motor, or the like) to incrementally and accurately reposition the mirrors. The adjustment of the mirrors is performed individually and independently based on the specifics of each mirror and the frames of reference. The system therefore ensures maximum visibility is provided to the driver 914, resulting in safer operation of the vehicle.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A system for mirror positioning, comprising:
at least one sensor configured to be located on a vehicle and including a field-of-view within the vehicle, wherein the vehicle includes at least one mirror configured to provide visibility of an environment external to the vehicle; and
a processing device in communication with the at least one sensor, wherein the processing device is configured to execute instructions stored in a memory to perform operations comprising:
detecting with the at least one sensor a face or eyes of a driver of the vehicle;
determining a position of the face or the eyes of the driver of the vehicle; and
based on the determined position of the face or the eyes of the driver of the vehicle, adjusting a position of the at least one mirror to optimize the visibility of the environment external to the vehicle in the at least one mirror for the driver.

2. The system of claim 1, wherein the at least one sensor is a camera and the field-of-view is directed towards the driver of the vehicle.

3. The system of claim 1, wherein the at least one mirror includes a right side mirror and a left side mirror.

4. The system of claim 1, wherein the at least one mirror includes a fender convex mirror, a door convex mirror, a rearview mirror, or combinations thereof.

5. The system of claim 1, wherein the operations comprise monitoring the position of the face or the eyes of the driver of the vehicle over time.

6. The system of claim 5, wherein the operations comprise readjusting the position of the at least one mirror based on a change in the position of the face or the eyes of the driver of the vehicle over time relative to an initial position of the face or the eyes of the driver of the vehicle.

7. The system of claim 6, wherein the operations comprise readjusting the position of the at least one mirror based on the change in the position of the face or the eyes of the driver of the vehicle in real-time.

8. The system of claim 6, wherein the operations comprise readjusting the position of the at least one mirror based on the change in the position of the face or the eyes of the driver of the vehicle after a predetermined period of time.

9. The system of claim 1, comprising a database with correlation data between the position of the face or the eyes of the driver and a target position of the least one mirror for optimized visibility of the environment eternal to the vehicle in the at least one mirror.

10. The system of claim 1, wherein detecting the face or the eyes of the driver and determining the position of the face or the eyes of the driver is performed before initial driving of the vehicle upon entry of the driver into the vehicle.

11. The system of claim 10, wherein detecting the face or the eyes of the driver and determining the position of the face or the eyes of the driver is performed upon a change in the driver of the vehicle.

12. The system of claim 1, wherein adjusting the position of the at least one mirror includes aligning the position of the at least one mirror with a line-of-sight of the eyes of the driver.

13. The system of claim 1, wherein adjusting the position of the at least one mirror comprises actuating a rotary unit associated with the at least one mirror to reposition the at least one mirror.

14. A computer-implemented method for mirror positioning, comprising:
detecting with at least one sensor configured to be located on a vehicle and including a field-of-view within the vehicle a face or eyes of a driver of the vehicle, wherein the vehicle includes at least one mirror configured to provide visibility of an environment external to the vehicle; and
executing instructions stored in a memory with a processing device in communication with the at least one sensor to perform operations comprising:
determining a position of the face or the eyes of the driver of the vehicle; and
based on the determined position of the face or the eyes of the driver of the vehicle, adjusting a position of the at least one mirror to optimize the visibility of the environment external to the vehicle in the at least one mirror for the driver.

15. The method of claim 14, wherein the operations comprise monitoring the position of the face or the eyes of the driver of the vehicle over time.

16. The method of claim 15, wherein the operations comprise readjusting the position of the at least one mirror based on a change in the position of the face or the eyes of the driver of the vehicle over time relative to an initial position of the face or the eyes of the driver of the vehicle.

17. The method of claim 16, wherein the operations comprise readjusting the position of the at least one mirror based on the change in the position of the face or the eyes of the driver of the vehicle in real-time.

18. The method of claim 16, wherein the operations comprise readjusting the position of the at least one mirror based on the change in the position of the face or the eyes of the driver of the vehicle after a predetermined period of time.

19. The method of claim 14, wherein detecting the face or the eyes of the driver and determining the position of the face or the eyes of the driver is performed before initial driving of the vehicle upon entry of the driver into the vehicle and/or upon a change in the driver of the vehicle.

20. The method of claim 14, wherein adjusting the position of the at least one mirror includes aligning the position of the at least one mirror with a line-of-sight of the eyes of the driver.
